(19) United States
(12) Patent Application Publication
(10) Pub. No.: US 2026/0266559 A1
(43) Pub. Date: Sep. 10, 2026

(54) Cellular Latent Heat Thermal Energy Storage System

(71) Applicant: City University of Hong Kong, Hong Kong (HK)

(72) Inventors: Gongsheng HUANG, Hong Kong (HK); Hang WAN, Hong Kong (HK); Bo LAN, Hong Kong (HK)

(21) Appl. No.: 19/554,659

(22) Filed: Mar. 3, 2026

Related U.S. Application Data
(60) Provisional application No. 63/768,199, filed on Mar. 7, 2025.

(51) Int. Cl. F28D 20/02; F28D 20/00

(52) U.S. Cl. CPC F28D 20/021; F28D 20/028; F28D 2020/0078

(57) ABSTRACT

The invention provides a cellular latent heat thermal energy storage (LHTES) system. The system comprises a plurality of LHTES modules, each LHTES module including an array of LHTES cells; a main balancing valve connected to a pliability of branch valves, each branch valve being connected to a corresponding LHTES module; and a controller. Each LHTES cell includes a plurality of micro-channels connecting an inlet and an outlet for allowing a heat transfer fluid to flow through the LHTES cell; the controller configured to: monitor a state of charge of the LHTES system; and adjusting the main balancing valve to control a flow rate of a heat transfer fluid (HTF) to regulate charging and discharging rate of HTF in the each LHTES cell as required by the building energy management and load regulation. The present invention can enhance building energy management flexibility, improve energy efficiency, and reduce operational costs.

### FIELD OF THE INVENTION

The present invention generally relates to thermal energy storage technologies. More specifically the present invention relates to a cellular latent heat thermal energy storage system.

### BACKGROUND OF THE INVENTION

Thermal energy storage (TES) systems can enhance power system efficiency by storing surplus energy when production exceeds demand and releasing it when demand surpasses supply. This is especially advantageous for power grids that rely heavily on renewable energy sources, where energy availability fluctuates or follows periodic patterns. Beyond preventing energy shortages, TES systems can also optimize efficiency and reduce costs for energy providers. They help minimize or eliminate the need to procure or generate expensive energy during peak demand periods and can lower capital expenses associated with expanding power generation capacity.

Unlike thermal chemical energy storage (TCES) systems, the phase change materials (PCMs) used in TES systems are non-toxic and environmentally friendly, helping to reduce the carbon footprint. Additionally, this eliminates the safety risks associated with handling and storing reactive chemicals compared to TCES systems.

Moreover, TES systems can leverage PCMs to store significantly more energy per unit mass compared to conventional sensible heat thermal energy storage systems (e.g. water and rock etc.). This allows for smaller storage cells and reduced spatial requirements, making them ideal for space-constrained buildings.

However, some existing TES systems have the problem in scaling up storage capacity because they adopt tube-and-shell designs, which make upgrades difficult and often disruptive due to their rigid structural configurations. This limitation reduces their adaptability to diverse energy management demands.

### SUMMARY OF THE INVENTION

To solve the abovesaid problem, the invention introduces a cellular latent heat thermal energy storage (LHTES) system through standardizing the cell, enabling seamless integration of cells to modules and modules to systems, and enhancing flexible scalability to accommodate varying storage capacities.

In accordance with one aspect of the present invention, the cellular LHTES system comprises a plurality of LHTES modules, each LHTES module including an array of LHTES cells; a main balancing valve connected to a plurality of branch valves, each branch valve being connected to a corresponding LHTES module; and a controller; wherein each LHTES cell includes an inlet; an outlet; and a plurality of micro-channels connecting the inlet and the outlet for allowing a heat transfer fluid to flow through the LHTES cell; the controller configured to: monitor a state of charge of the LHTES system; and adjust the main balancing valve to control a flow rate of a heat transfer fluid (HTF) to regulate charging and discharging rate of HTF in the each LHTES cell as required by the building energy management and load regulation.

In one embodiment, the cellular LHTES system further comprises a plurality of branch control valves, each branch control valve being connected between the main balancing valve and a corresponding LHTES module.

In one embodiment, the controller is further configured to switch on/off each of the plurality of branch control valves to set the plurality of LHTES module to an on/off state respectively.

In one embodiment, each LHTES cell includes a shell being sealed with an insulated material.

In one embodiment, each LHTES cell further includes an injection hole for injecting and filling phase change material into spaces between the micro-channels within the shell.

In one embodiment, the plurality of micro-channels is arranged in parallel to each other.

In one embodiment, the controller is configured to maintain the flow rate of a heat transfer fluid to be a constant value.

In one embodiment, the heat transfer fluid is selected from water, ethylene glycol-water mixture, propylene glycol-water mixture, or similar fluids.

In one embodiment, the phase change material is selected from paraffins, fatty acids, polyethylene glycol or other similar materials.

The proposed LHTES system has significant market potential. In building heating and cooling, it serves as a thermal buffer, increasing efficiency and reducing costs. In the renewable energy system, it stores excess solar or wind energy for low-output periods. In industry, it enables precise temperature control by accurately managing heat charge and discharge.

### BRIEF DESCRIPTION OF THE DRAWINGS

Embodiments of the invention are described in more details hereinafter with reference to the drawings, in which:

FIG. 1 depicts a LHTES system in accordance with one embodiment of the present invention;

FIG. 2 depicts a schematic diagram illustrating how LHTES cells are integrated to form a LHTES module in accordance with one embodiment of the present invention.

FIG. 3A depicts a design of LHTES cell in accordance with one embodiment of the present invention; FIG. 3B shows a top view of the LHTES cell; FIG. 3C shows a side view of the LHTES cell; FIG. 3D shows a cross-section view of the LHTES cell along line A-A’ in FIG. 3B; and FIG. 3E shows a cross-section view of the LHTES cell along line B-B’ in FIG. 3C.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

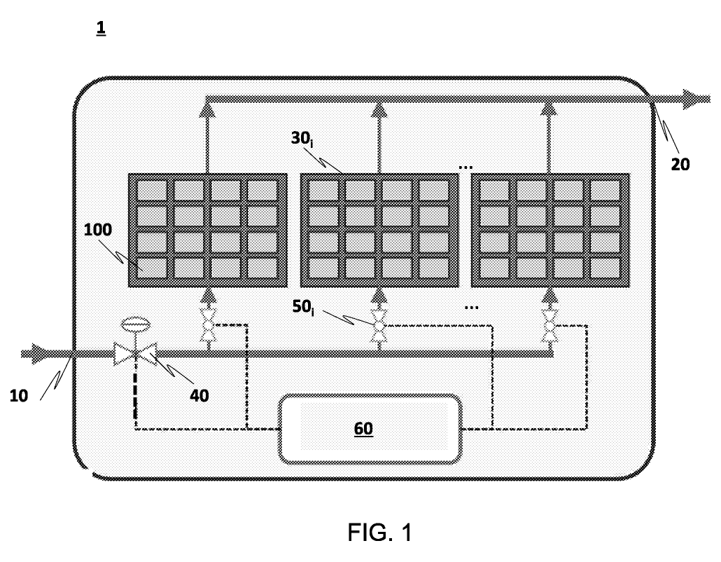

FIG. 1 depicts a cellular LHTES system 1 in accordance with one embodiment of the present invention. The system 1 comprises a plurality of LHTES modules 10i connected between a heat transfer fluid (HTF) input port 20 and a HTF output port 30 through a plurality of inter-module pipes.

The system 1 further comprises a main balancing valve 40 connected between the input port 20 and a plurality of branch control valves 50ᵢ. Each branch control valve 50ᵢ is connected to a corresponding LHTES module 10ᵢ.

The system 1 further comprises a controller 60 configured to monitor the State of Charge (SOC) of the LHTES system to determine whether to: (1) charge, (2) discharge, or (3) maintain the current state according to requirements by the building energy management and load regulation.

More specifically, the controller 60 controls flowrate of HTF according to the LHTES charging and discharging characteristics by adjusting the openness of the main balancing valve 40 to regulate charging and discharging rate of the LHTES system to follow the charging/discharging power as required by the building energy management and load regulation. The controller 60 further switches on/off the branch control valve 50ᵢ for each module 10ᵢ to specify ON/OFF state of the LHTES module 10ᵢ.

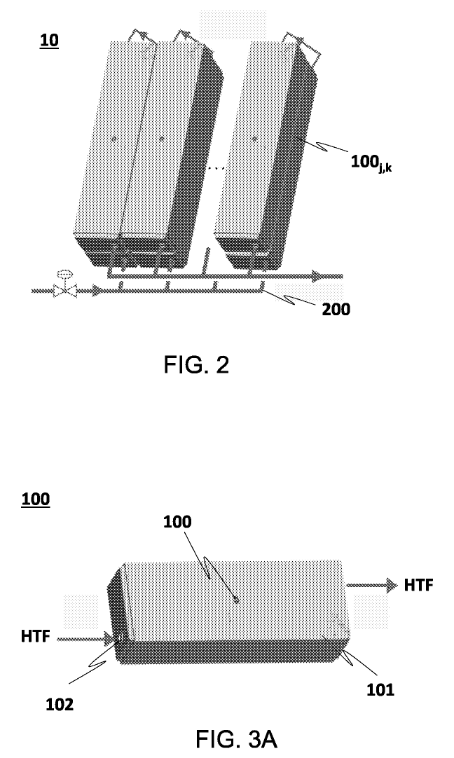

Referring to FIG. 2, each LHTES module 10 includes an MxL array of LHTES cells 100_{j,k}. , where j = 1, 2, …, M, and k = 1, 2, …, L. The LHTES cells 100_{j,k} are connected in series and parallel through a plurality of inter-cell pipes 200 to form the LHTES module 10.

This control and operation scheme can track the predetermined charging or discharging power curve, thus enhance building energy management flexibility, improve energy efficiency, and reduce operational costs, and is applicable in Heating Ventilation and Air Conditioning (HVAC) systems, domestic hot water systems, and industrial energy systems.

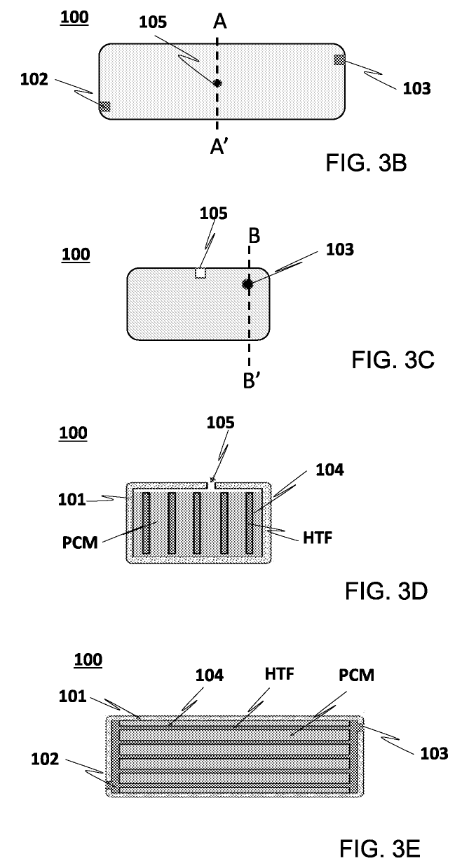

Referring to FIGS. 3A to 3E, each LHTES cell 100 includes a shell 101, a heat transfer fluid (HTF) inlet 102, a HTF outlet 103 and a plurality of tubes (or micro-channels) 104 connecting the HTF inlet 102 and the HTF outlet 103 for allowing HTF to flow through the LHTES cell 100.

The plurality of tubes 104 is arranged in parallel to each other. The HTF flows inside the multiple parallel micro-channels. During operation, the HTF flowrate of cells is maintained to be a constant value.

Each LHTES cell 100 further includes a PCM injection hole 105 for injecting and filling PCM into spaces between the micro-channels 104 within the LHTES cell 100. In other words, the HTF flowing inside the micro-channels are surrounded by PCMs for heat exchange.

In some embodiments, the HTF is selected from water, ethylene glycol-water mixture, propylene glycol-water mixture, or similar fluids.

In some embodiments, the PCM is selected from paraffins, fatty acids, polyethylene glycol or other similar materials.

The main function of this patent is to provide a LHTES scalable design with accurate control of LHTES charging and discharging rate, which can be used to enhance the flexibility of building energy use and reducing energy consumption and operational costs. This patent can be integrated with energy management systems, then optimized load-shaping techniques can be applied within this system based on grid load and price fluctuations.

The controller 60 is configured to govern the thermal behavior of the cellular LHTES system by operating both system-level and module-level flow control components. In operation, the controller 60 receives data indicative of the instantaneous charging or discharging condition of the LHTES system, such as inlet and outlet temperatures of the heat transfer fluid (HTF), module saturation state, historical load patterns, and real-time building energy management requirements. Based on these inputs, the controller 60 generates a flow-regulation signal that commands the main balancing valve 40.

In one embodiment, the controller 60 is configured to operate in conjunction with a set of sensing units distributed throughout the LHTES system. The sensing units may include inlet temperature sensors positioned upstream of the main balancing valve 40, outlet temperature sensors located downstream of the LHTES modules 10i, differential pressure sensors across the pipes, and module-level temperature probes that reflect the phase-state progression of the latent heat storage material within each module 10i. The controller 60 receives these sensor signals as real-time input data for determining the thermal state of the system, identifying charging or discharging readiness, and estimating available residual capacity within the active modules.

The main balancing valve 40 is configured to modulate the total HTF flowrate entering the inter-module pipes that feeds the plurality of LHTES modules 10ᵢ. By adjusting the valve opening, the controller 60 directs the HTF to circulate at a rate aligned with the desired charging or discharging intensity. When the building requires rapid energy absorption into the LHTES system, the controller 60 increases the opening of the main balancing valve 40 so that a higher HTF flowrate passes through the modules, accelerating heat exchange between the HTF and the PCM. Conversely, during partial-load or maintenance conditions, the controller 60 reduces the valve opening to limit the flowrate, allowing the LHTES system to adapt dynamically to varying thermal loads with stable operational efficiency.

At the module level, the controller 60 is configured to operate a set of branch control valves 50ᵢ, each corresponding to a respective LHTES module 10ᵢ. The controller 60 issues individual ON/OFF commands to the branch control valves 50ᵢ, thereby designating whether a given module is active in the current charging or discharging cycle. When a branch control valve 50ᵢ is placed in the ON state, the associated module 10ᵢ becomes hydraulically engaged with the HTF loop. HTF is allowed to flow through the associated module 10ᵢ, enabling heat exchange and contributing to system-level capacity. When the branch control valve 50ᵢ is turned OFF, the module is hydraulically isolated from the HTF loop. This allows the system to selectively activate any combination of modules and dynamically scale the system capacity up or down depending on the required storage capacity, the thermal state of each module, maintenance scheduling, or load-shifting strategies imposed by the building energy management platform.

Through coordinated control of the main balancing valve 40 and the branch control valves 50ᵢ, the controller 60 enables hierarchical flow management: the main balancing valve 40 sets the aggregate charging or discharging rate at the system level, while the branch control valves 50ᵢ define how this total flow is distributed across individual modules. This configuration provides a modular, scalable, and responsive thermal storage mechanism suitable for both steady-state operation and rapidly changing load environments. The controller 60 can also cycle modules sequentially to balance thermal loads and distribute material fatigue, extending the operational life of the LHTES array.

In some embodiments, the controller 60 is further configured to incorporate predictive control logic. The controller 60 may receive building load forecasts or time-of-use energy pricing data from a building management system. Using these data, the controller 60 anticipates periods of high or low thermal demand and pre-adjusts both the main balancing valve 40 and the branch control valves 50ᵢ accordingly. For example, when a peak-demand period is predicted, the controller 60 may initiate a full-capacity charging cycle during off-peak hours by activating a majority of the modules 10ᵢand increasing flow through the main balancing valve 40. Likewise, when minimal thermal demand is forecasted, the controller 60 may deactivate selected modules to conserve energy while maintaining system readiness.

Redundancy and fault-handling mechanisms may also be implemented. The controller 60 is configured to detect abnormal temperature gradients or pressure drops that indicate failure of a branch control valve 50ᵢ or flow obstruction within a module 10ᵢ. Upon detecting such conditions, the controller 60 may automatically isolate the affected module by closing its branch control valve 50ᵢ, while redistributing HTF flow among the remaining modules. The main balancing valve 40 may then be adjusted to maintain system-level thermal performance despite the reduced module count. Data logs of such events may be stored for maintenance scheduling and system diagnostics.

Through coordinated operation of the main balancing valve 40 and the plurality of branch control valves 50ᵢ, the controller 60 establishes a hierarchical flow management structure. The upper layer, dictated by the main balancing valve 40, sets the global charging or discharging intensity by controlling aggregate HTF flowrate. The lower layer, governed by the branch control valves 50ᵢ, determines the spatial distribution of flow among the modules 10ᵢ. Combined with real-time sensing and predictive data inputs, this structure provides a highly adaptable thermal energy storage platform capable of responding swiftly to fluctuating building loads while maintaining stable and efficient operation across diverse thermal scenarios.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A cellular latent heat thermal energy storage (LHTES) system, comprising:
a plurality of LHTES modules, each LHTES module including an array of LHTES cells;
a main balancing valve connected to a pliability of branch valves, each branch valve being connected to a corresponding LHTES module; and
a controller;
wherein each LHTES cell includes an inlet; an outlet; and a plurality of micro-channels connecting the inlet and the outlet for allowing a heat transfer fluid to flow through the LHTES cell; and
the controller configured to:
monitor a state of charge of the LHTES system; and
adjust the main balancing valve to control a flow rate of a heat transfer fluid (HTF) to regulate charging and discharging rate of HTF in the each LHTES cell as required by the building energy management and load regulation.

2. The cellular latent heat thermal energy storage (LHTES) system according to claim 1, further comprising a plurality of branch control valves, each branch control valve being connected between the main balancing valve and a corresponding LHTES module.

3. The cellular latent heat thermal energy storage (LHTES) system according to claim 1, wherein the controller is further configured to switch on/off each of the plurality of branch control valves to set the plurality of LHTES module to an on/off state respectively.

4. The cellular latent heat thermal energy storage (LHTES) system according to claim 3, wherein each LHTES cell includes a shell being sealed with an insulated material.

5. The cellular latent heat thermal energy storage (LHTES) system according to claim 4, wherein each LHTES cell further includes an injection hole for injecting and filling a phase change material into spaces between the micro-channels within the shell.

6. The cellular latent heat thermal energy storage (LHTES) system according to claim 5, wherein the phase change material is a paraffin, a fatty acid or a polyethylene glycol.

7. The cellular latent heat thermal energy storage (LHTES) system according to claim 1, wherein the plurality of micro-channels is arranged in parallel to each other.

8. The cellular latent heat thermal energy storage (LHTES) system according to claim 1, wherein the controller is further configured to maintain the flow rate of the heat transfer fluid to be a constant value.

9. The cellular latent heat thermal energy storage (LHTES) system according to claim 1, wherein the heat transfer fluid is water, an ethylene glycol solution or a propylene glycol solution.
